(19) United States
(12) Patent Application Publication
(10) Pub. No.: US 2016/0165891 A1
(43) Pub. Date: Jun. 16, 2016

(54) SYNERGISTIC HERBICIDAL COMPOSITION CONTAINING PENOXSULAM, TRICLOPYR AND BISPYRIBAC

(71) Applicant: Dow AgroSciences LLC, Indianapolis, IN (US)

(72) Inventors: Nelson M. Carranza Garzon, Bogota (CO); Richard K. Mann, Franklin, IN (US); Ruby A. Pacheco, Villvicencio (CO)

(73) Assignee: Dow AgroSciences LLC, Indianapolis, IN (US)

(21) Appl. No.: 14/947,499

(22) Filed: Nov. 20, 2015

Related U.S. Application Data
(60) Provisional application No. 62/092,635, filed on Dec. 16, 2014.

(51) Int. Cl. A01N 43/90; A01N 43/54; A01N 43/40

(52) U.S. Cl. CPC A01N 43/90; A01N 43/40; A01N 43/54

(57) ABSTRACT

Methods for controlling weeds using synergistic compositions containing penoxsulam, triclopyr, and bispyribac, especially rice, sugarcane, cereal and grain crops, pastures, rangelands, industrial vegetation management (IVM), aquatics and turf, as well as protecting crops from herbicidal injury caused by any of the individual components. These methods provide improved post-emergence herbicidal weed control and reduce herbicidal injury by concomitant application of the mixture.

### CROSS REFERENCE TO RELATED APPLICATIONS

This application claims the benefit of U.S. Provisional Patent Application Ser. No. 62/092,635 filed Dec. 16, 2014, which is expressly incorporated by reference herein.

### BACKGROUND

The protection of crops from weeds and other vegetation which inhibit crop growth is a recurring problem in agriculture. To help combat this problem, a variety of chemicals and chemical formulations effective in the control of unwanted vegetation have been synthesized and evaluated. Different classes of chemical herbicides have been disclosed in the literature and a large number are in commercial use. However, there remains a need for improved compositions and methods of use thereof that are effective in controlling undesirable vegetation.

### SUMMARY

The methods described herein can be used for controlling undesirable vegetation. The methods include contacting the vegetation or the locus thereof with a synergistic mixture of (a) penoxsulam or agriculturally acceptable salts thereof, (b) triclopyr or agriculturally acceptable salts or esters thereof, and (c) bispyribac or agriculturally acceptable salts or esters thereof.

Additionally, the methods described herein can be used to protect crops from the harmful effects of one or more of penoxsulam, triclopyr, and bispyribac. The methods include contacting the crop with a synergistic mixture of (a) penoxsulam or agriculturally acceptable salts thereof, (b) triclopyr or agriculturally acceptable salts or esters thereof, and (c) bispyribac or agriculturally acceptable salts or esters thereof

### DETAILED DESCRIPTION

Penoxsulam and bispyribac are active against a broad range of weeds and are highly complementary with triclopyr. For example, it has been found that a combination of penoxsulam, triclopyr and bispyribac exhibits a synergistic action in the control of a variety of weeds, such as Digitaria species (DIGSS), Echinochloa colonum (L.) LINK (junglerice, ECHCO), Ischaemum rugosum (saramollagrass, ISCRU) and Rottboellia exaltata (guineafowlgrass, ROOEX) at application rates equal to or lower than the rates of the individual compounds.

### I. DEFINITIONS

As used herein, penoxsulam is 2-(2,2-difluoroethoxy)-N-(5,8-dimethoxy-[1,2,4]triazolo[1,5-c]pyrimidin-2-yl)-6-(trifluoromethyl)benzenesulfonamide, which has the following structure:

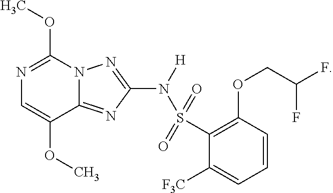 [SMILES: COc1cnc(OC)n2nc(NS(=O)(=O)c3c(OCC(F)F)cccc3C(F)(F)F)nc12]

Exemplary uses of penoxsulam are described in Tomlin, C. D. S., Ed. The Pesticide Manual: A World Compendium, 15^{th} ed.; BCPC: Alton, 2009 (hereafter “The Pesticide Manual, Fifteenth Edition, 2009”) and include, but are not limited to, control of Echinochloa spp., as well as many broadleaf, sedge and aquatic weeds in rice, Apera spp., a genus of annual grasses, and many broadleaf weeds in cereals.

As used herein, triclopyr is 2[(3,5,6-trichloro-2-pyridinyl)oxy]acetic acid, which has the following structure:

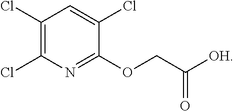 [SMILES: O=C(O)COc1nc(Cl)c(Cl)cc1Cl]

Exemplary uses of triclopyr are described in The Pesticide Manual, Fifteenth Edition, 2009 and include, but are not limited to, control of a wide range of woody plants and broadleaf weeds. Exemplary chemical forms of triclopyr include, for example, triclopyr TEA, which is triethylammonium 2[(3,5,6-trichloro-2-pyridinyl)oxy]acetate and has the following structure:

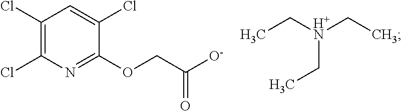

triclopyr choline, which is 2-hydroxy-N,N,N-trimethylethanaminium 2-[(3,5,6-trichloro-2-pyridinyl)oxy]acetate and has the following structure:

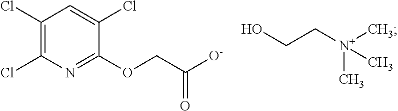

and

triclopyr BEE, which is 2-butoxyethyl 2[(3,5,6-trichloro-2-pyridinyl)oxy]acetate and has the following structure:

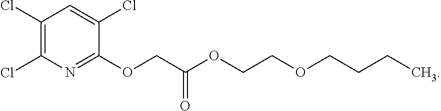 [SMILES: CCCCOCCOC(=O)COc1nc(Cl)c(Cl)cc1Cl]

As used herein, bispyribac is 2,6-bis((4,6-dimethoxypyrimidin-2-yl)oxy)benzoic acid, which has the following structure:

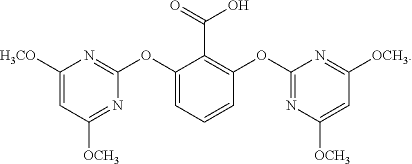 [SMILES: COc1cc(OC)nc(Oc2cccc(Oc3nc(OC)cc(OC)n3)c2C(=O)O)n1]

Exemplary uses of bispyribac are described in The Pesticide Manual, Fifteenth Edition, 2009 and include, but are not limited to, control of many grasses, sedges, and broadleaf weeds, especially Echinochloa spp., in direct-seeded rice, as well to stunt growth of weeds in non-crop situations. Exemplary chemical forms of bispyribac include, for example, bispyribac-sodium, which is sodium 2,6-bis((4,6-dimethoxypyrimidin-2-yl)oxy)benzoate and has the following structure:

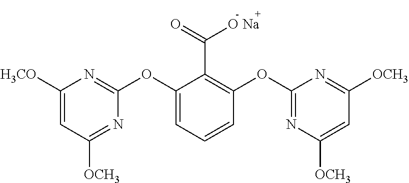

The term herbicide, as used herein, means an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect such as a deviation from natural development, killing, regulation, desiccation and retardation.

As used herein, “plants” and “vegetation” include, but are not limited to, germinant seeds, emerging seedlings, plants emerging from vegetative propagules, and established immature and mature vegetation.

As used herein, immature vegetation refers to plants prior to their reproductive stage, and mature vegetation refers to plants during and after their reproductive stage.

### II. COMPOSITIONS

A. Synergistic Combinations

Provided herein are herbicidal compositions containing a mixture containing synergistic, herbicidally effective amounts of:

(a) penoxsulam or agriculturally acceptable salts thereof

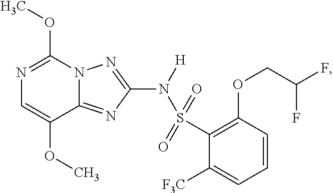 [SMILES: COc1cnc(OC)n2nc(NS(=O)(=O)c3c(OCC(F)F)cccc3C(F)(F)F)nc12]

(b) triclopyr or agriculturally acceptable salts or esters thereof

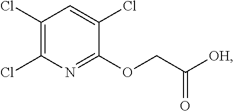 [SMILES: O=C(O)COc1nc(Cl)c(Cl)cc1Cl]

and

(c) bispyribac or agriculturally acceptable salts or esters thereof

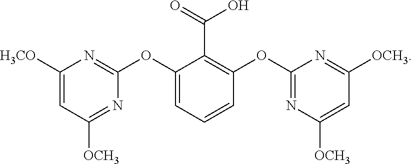 [SMILES: COc1cc(OC)nc(Oc2cccc(Oc3nc(OC)cc(OC)n3)c2C(=O)O)n1]

Agriculturally acceptable salts and esters of triclopyr are anticipated to control undesirable vegetation in combination with penoxsulam and a salt or ester of bispyribac. Examples of such agriculturally acceptable salts and esters of triclopyr include, but are not limited to, triclopyr-butotyl, triclopyr-ethyl, triclopyr-triethylammonium (TEA) salt, and triclopyr-choline salt.

Agriculturally acceptable salts and esters of bispyribac are anticipated to control undesirable vegetation in combination with penoxsulam and a salt or ester of triclopyr. An example of such an agriculturally acceptable salt of bispyribac includes bispyribac-sodium.

Furthermore, in some embodiments, the combination of the three actives exhibits synergism, i.e. the herbicidal active ingredients are more effective in combination than when applied individually. Synergism has been defined as “an interaction of two or more factors such that the effect when combined is greater than the predicted effect based on the response to each factor applied separately.” (Shaner, D. L., Ed. Herbicide Handbook, 10^{th} ed. Lawrence: Weed Society of America, 2014.) In certain embodiments, the compositions exhibit synergy as determined by Colby's equation. (Colby, S. R. Calculation of the synergistic and antagonistic response of herbicide combinations. Weeds 1967, 15, 20-22.)

Herbicidal or safening activity is exhibited by the compounds when they are applied pre- and post-emergence directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, the amount of chemical applied, and combinations thereof. These and other factors can be adjusted to promote non-selective or selective herbicidal action or safening activity. In some embodiments, the compositions described herein are applied as a post-emergence application to relatively immature and mature undesirable vegetation to achieve the maximum control of weeds.

In some embodiments, penoxsulam or an agriculturally acceptable salt thereof, triclopyr or an agriculturally acceptable salt or ester thereof, and bispyribac or an agriculturally acceptable salt or ester thereof are used in combination with other herbicides which complement the spectrum of weeds controlled by these compounds at the application rate employed. In some embodiments, the compositions described herein and other complementary herbicides are applied simultaneously, either as a combination formulation or as a tank mix.

The present compositions can be applied to weeds or their locus thereof, including but not limited to, foliage, water or soil, by the use of conventional ground or aerial dusters, sprayers, and granule applicators, by addition to irrigation or paddy water, and by other conventional means known to those skilled in the art.

In some embodiments, the concentration of the active ingredients in the synergistic composition described herein is from about 0.001 to 98 percent by weight. In some embodiments, the concentration is from 0.01 to 90 percent by weight. In compositions designed to be employed as concentrates, the active ingredients, in certain embodiments, are present in a concentration from about 0.1 to 98 weight percent, and in some embodiments from about 0.5 to 90 weight percent. Such compositions are, in some embodiments, diluted with an inert carrier, such as water, before application, or applied as a dry or liquid formulation directly into flooded rice fields. The diluted compositions usually applied to weeds or the locus of weeds contain, in certain embodiments, about 0.0001 to 10 weight percent active ingredient and in certain embodiments contain about 0.001 to 5.0 weight percent.

In certain embodiments of the compositions and methods of use thereof described herein, penoxsulam is used in combination with triclopyr and bispyribac. With regard to the compositions, in some embodiments, the weight ratio of penoxsulam or salt thereof (in grams active ingredient per hectare (g ai/ha) to triclopyr or salt or ester thereof (in g ai/ha) to bispyribac or salt or ester thereof (in g ai/ha) is within the range from about 1:1600:20 to about 1:0.63:0.05, from about 1:800:6 to about 1:3.33:0.25, from about 1:1600:1 to about 1:0.63:1, from about 1:800:1.5 to about 1:3.33:1, from about 1:12.6:20 to about 1:80:0.05, from about 1:133.33:1 to about 1:20:1.5, from about 1:20:1.5 to about 1:133.33:3 and from about 1:80:1 to about 1:12.6:1. In certain embodiments, the weight ratio of penoxsulam or salt thereof to triclopyr or salt or ester thereof to bispyribac or salt or ester thereof is within the range from about 1:3.33:1 to about 1:20:1, from about 1:5:1 to about 1:15:1 and from 1:6:1 to about 1:10:1. In other embodiments, the weight ratio of penoxsulam or salt thereof to triclopyr or salt or ester thereof to bispyribac or salt or ester thereof is within the range from about 1:8.33:1.67 to about 1:8.33:1.33.

In certain embodiments of the compositions and methods of use thereof described herein, a premix of penoxsulam and triclopyr is used in combination with bispyribac. With regard to the compositions, in some embodiments, the weight ratio of the premix of penoxsulam or salt thereof plus triclopyr or salt or ester thereof (in g ai/ha) to bispyribac or salt or ester thereof (in g ai/ha) is within the range from about 1:1.47 to about 1620:1, from about 1:1.2 to about 1200:1, from about 1:1 to about 1000:1, from about 1:0.8 to about 800:1, from about 1:0.6 to about 700:1, from about 1:4 to about 650:1, from about 1:0.29 to about 537:1, from about 1:0.25 to about 500:1, from about 1:0.2 to about 400:1, from about 1:0.18 to about 300:1, from about 1:0.15 to about 200:1, from about 1:0.125 to about 175:1, from about 1:0.1 to about 150:1, from about 1:0.071 to about 134:1, from about 1:0.074 to about 81:1, from about 1:0.05 to about 50:1. In certain embodiments, the weight ratio of the premix of penoxsulam or salt thereof plus triclopyr or salt or ester thereof to bispyribac or salt or ester thereof is within the range from about 1:0.19 to about 7.3:1. In other embodiments, the weight ratio of penoxsulam or salt thereof plus triclopyr or salt or ester thereof to bispyribac or salt or ester thereof is within the range from about 1:0.18 to about 7:1.

The rate at which the synergistic composition is applied will depend upon the particular type of weed to be controlled, the degree of control required, and the timing and method of application. Bispyribac is typically applied at a rate from about 5 grams active ingredient per hectare (g ai/ha) to about 100 g ai/ha. Penoxsulam is typically applied at a rate from about 5 to about 100 g ai/ha, and triclopyr is typically applied at a rate from about 63 to about 8000 g ai/ha. When premixed, penoxsulam plus triclopyr is typically applied at a rate from about 68 g ai/ha to about 8060 g ai/ha.

With respect to the methods, in certain embodiments, the methods include contacting the undesirable vegetation with a composition described herein. In some embodiments, the composition is applied at an application rate from about 73 g ai/ha to about 8200 g ai/ha based on the total amount of active ingredients in the composition. In certain embodiments, the composition is applied at an application rate from about 225 g ai/ha to about 8120 g ai/ha based on the total amount of active ingredients in the composition. In certain embodiments, the composition is applied at an application rate from about 330 g ai/ha to about 416 g ai/ha based on the total amount of active ingredients in the composition.

The components of the mixtures described herein can be applied as a tank-mix or as part of a mixture or multipart herbicidal system. In some embodiments, all three components may be formulated together (e.g., in the same formulation) or separately (e.g., in separate formulations) and applied simultaneously. Alternatively, two of the three components can be formulated together (e.g., penoxsulam and triclopyr) and the third component formulated separately and the two formulations applied simultaneously.

In one embodiment, the compositions exhibit synergy against a variety of weeds. In one embodiment, the combination of penoxsulam or salt thereof, triclopyr or salt or ester thereof, and bispyribac or salt or ester thereof in a ratio of about 1:8.33:1.73 to about 1:8.33:1.28 exhibits greater than about 3, 5, 7, 9, 11, 15, 18, 20, 21, 22.5, 24, 25, 27, 45, 50, 55. 97 or 99% control compared to the Colby predicted value at 6-40 days after application (DAA).

In another embodiment, the compositions exhibit synergy in reducing crop injury. In one embodiment, the combination of penoxsulam or salt thereof, triclopyr or salt or ester thereof, and bispyribac or salt or ester thereof in a ratio of about 1:8.33:1.73 to about 1:8.33:1.28 exhibits reductions of about 5, 6, 7, 8, 9, 10, 12, 14, or 15% crop injury compared to the Colby predicted value at 6-27 days after application (DAA).

In another embodiment, the compositions exhibit synergy against a variety of weeds, including but not limited to, Digitaria species (DIGSS), Echinochloa colonum (L.) LINK (junglerice, ECHCO), Ischaemum rugosum (saramollagrass, ISCRU) and Rottboellia exaltata (guineafowlgrass, ROOEX).

In a further embodiment, the combination of penoxsulam or salt thereof, triclopyr or salt or ester thereof, and bispyribac or salt or ester thereof in a ratio of about 1:8.33:1.73 to about 1:8.33:1.28 exhibits (1) greater than about 95 or 98% control of DIGSS compared to the Colby predicted value; (2) greater than about 97% control of ECHCO compared to the Colby predicted value; (3) greater than about 15, 20, 22.5, 25, 45, 50, 55, 97, or 99% control of ISCRU compared to the Colby predicted value; and/or (4) greater than about 75, 80, 85, 90, 95 or 98% control of ROOEX compared to the Colby predicted value at 6-40 days after application.

In one embodiment, the combination of penoxsulam or salt thereof, triclopyr or salt or ester thereof, and bispyribac or salt or ester thereof in a ratio of about 1:8.33:1.73 to about 1:8.33:1.28 exhibits less than about 7, 4, 3.5, 3, 2.5, 2, 1.5, 1 or 0.5% crop injury compared to the Colby predicted value at 6-27 DAA.

In another embodiment, the compositions exhibit safening activity to a variety of crops, including but not limited to, rice, wheat, barley, oats, rye, sorghum, corn, maize, sugarcane, pastures, grasslands, rangelands, fallowland, non-cropland, turf, industrial vegetation management (IVM) and aquatics.

In a further embodiment, the combination of penoxsulam or salt thereof, triclopyr or salt or ester thereof, and bispyribac or salt or ester thereof in a ratio of about 1:8.33:1.73 to about 1:8.33:1.28 exhibits less than about 7, 4, 3.5, 3, 2.5, 2, 1.5, 1, or 0.5% crop injury to ORYSA compared to the Colby predicted value at 6-27 days after application.

B. Other Actives

The mixtures described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the compositions and methods described herein include, but are not limited to: 4-CPA, 4-CPB, 4-CPP, 2,4-D, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilifos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, bentazon-sodium, benthiocarb, benzadox, benzfendizone, benzipram, benzobicyclon, benzofenap, benzofluor, benzoylprop, benzthiazuron, bicyclopyrone, bifenox, bilanafos, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clacyfos, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate, glufosinate-ammonium, glufosinate-P-ammonium, glyphosate, halauxifen, halosafen, halosulfuron-methyl, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, sethoxydim, siduron, simazine, simeton, simetryn, SMA, S-metolachlor, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiocarbazil, tioclorim, tolpyralate, topramezone, tralkoxydim, triafamone, tri-allate, triasulfuron, triaziflam, tribenuron, tribenuron-methyl, tricamba, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

The synergistic composition described herein can, further, be used in conjunction with glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, and bromoxynil on glyphosate-tolerant, glufosinate-tolerant, dicamba-tolerant, phenoxy auxin-tolerant, pyridyloxy auxin-tolerant, aryloxyphenoxypropionate-tolerant, ACCase-tolerant, imidazolinone-tolerant, ALS-tolerant, HPPD-tolerant, PPO-tolerant, triazine-tolerant, bromoxynil-tolerant crops, and crops possessing multiple or stacked traits conferring tolerance to multiple chemistries and/or multiple modes-of-action. In some embodiments, the composition described herein, an agriculturally acceptable salt or ester thereof and a complementary herbicide or salt or ester thereof are used in combination with herbicides that are selective for the crop being treated and which complement the spectrum of weeds controlled by these compounds at the application rate employed. In some embodiments, the composition described herein and other complementary herbicides are applied at the same time, either as a combination formulation or as a tank mix.

C. Safeners

In some embodiments, the synergistic composition described herein is employed in combination with known herbicide safeners, such as AD-67 (MON 4660), benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, MG 191, naphthalic anhydride (NA), oxabetrinil, R29148 and N-phenyl-sulfonylbenzoic acid amides, 1-[4-(N-(2-methoxybenzoyl)sulfamoyl)phenyl]-3-methylurea, N-(2-methoxybenzoyl)-4-[(methylaminocarbonyl)amino]benzenesulfonamide, to enhance their selectivity. In some embodiments, the safener is cloquintocet or an ester or salt thereof. In certain embodiments, cloquintocet is utilized to antagonize harmful effects of the compositions on rice and cereals. In some embodiments, the safener is cloquintocet (mexyl).

D. Adjuvants/Carriers

In some embodiments, the synergistic composition provided herein further comprises at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a pre-mix or tank-mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99; paraffinic oil, alkoxylated alcohol non-ionic surfactant; mineral oil, surfactant blend.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier of choice for the dilution of concentrates.

Suitable solid carriers include, but are not limited to, talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the composition described herein further comprises one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual,” MC Publishing Corporation: Ridgewood, N J, 1998, and in Encyclopedia of Surfactants, Vol. I-III, Chemical Publishing Company: New York, 1980-81. Surface-active agents include, but are not limited to, salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include, but are not limited to, compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

### III. METHODS OF USE

Methods of controlling undesirable vegetation by contacting the vegetation or the locus thereof, i.e., area adjacent to the vegetation, with a herbicidally effective amount of (a) penoxsulam or agriculturally acceptable salts thereof, (b) triclopyr or agriculturally acceptable salts or esters thereof, and (c) bispyribac or agriculturally acceptable salts or esters thereof are described herein. In certain embodiments, the methods employ the compositions described herein.

Methods of safening herbicidal injury to crops, such as rice, by contacting the vegetation or the locus thereof, i.e., area adjacent to the vegetation, with a herbicidally effective amount of (a) penoxsulam or agriculturally acceptable salts thereof, (b) triclopyr or agriculturally acceptable salts or esters thereof and (c) bispyribac or agriculturally acceptable salts or esters thereof are also described. In certain embodiments, the methods employ the compositions described herein.

In some embodiments, the compounds and compositions provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Digitaria species (DIGSS), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (small-flower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SCPJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rottboellia exaltata (guineafowlgrass, ROOEX), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some embodiments, the methods provided herein are utilized to control undesirable vegetation found in row crops, cereal crops, tree and vine crops, perennial crops and non-crop/IVM. In certain embodiments, the undesirable vegetation is Alopecurus myosuroides Huds. (blackgrass, ALOMY), Amaranthus palmeri S. Wats. (Palmer amaranth, AMAPA), Avena fatua L. (wild oat, AVEFA), Brachiaria decumbens Stapf. or Urochloa decumbens (Stapf) R. D. Webster (Surinam grass, BRADC), Brachiaria brizantha (Hochst. ex A. Rich.) Stapf. or Urochloa brizantha (Hochst. ex A. Rich.) R. D. (beard grass, BRABR), Brachiaria platyphylla (Groseb.) Nash or Urochloa platyphylla (Nash) R. D. Webster (broadleaf signalgrass, BRAPP), Brachiaria plantaginea (Link) Hitchc. or Urochloa plantaginea (Link) R. D. Webster (alexandergrass, BRAPL), Cenchrus echinatus L. (southern sandbur, CENEC), Digitaria horizontalis Willd. (Jamaican crabgrass, DIGHO), Digitaria insularis (L.) Mez ex Ekman (sourgrass, TRCIN), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Eleusine indica (L.) Gaertn. (goosegrass, ELEIN), Lolium multiflorum Lam (Italian ryegrass, LOLMU), Panicum dichotomiflorum Michx. (fall panicum, PANDI), Panicum miliaceum L. (wild-proso millet, PANMI), Sesbania exaltata (Raf.) Cory/Rydb. Ex Hill (hemp sesbania, SEBEX), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Anoda cristata (L.) Schlecht. (spurred anoda, ANVCR), Asclepias syriaca L. (common milkweed, ASCSY), Bidens pilosa L. (hairy beggarticks, BIDPI), Borreria species (BOISS), Borreria alata (Aubl.) DC. or Spermacoce alata Aubl. (broadleaf buttonweed, BOILF), Spermacose latifolia (broadleaved button weed, BOILF), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Euphorbia hirta L. or Chamaesyce hirta (L.) Millsp. (garden spurge, EPHHI), Euphorbia dentata Michx. (toothed spurge, EPHDE), Erigeron bonariensis L. or Conyza bonariensis (L.) Cronq. (hairy fleabane, ERIBO), Erigeron canadensis L. or Conyza canadensis (L.) Cronq. (horseweed, ERICA), Conyza sumatrensis (Retz.) E. H. Walker (tall fleabane, ERIFL), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Richardia species (pusley, RCHSS), Salsola tragus L. (Russian thistle, SASKR), Sida species (sida, SIDSS), Sida spinosa L. (prickly sida, SIDSP), Sinapis arvensis L. (wild mustard, SINAR), Solanum ptychanthum Dunal (eastern black nightshade, SOLPT), Tridax procumbens L. (coat buttons, TRQPR), or Xanthium strumarium L. (common cocklebur, XANST).

In some embodiments, the methods provided herein are utilized to control undesirable vegetation in range and pasture. In certain embodiments, the undesirable vegetation is Amaranthus palmeri S. Wats. (Palmer amaranth, AMAPA), Ambrosia artemisiifolia L. (common ragweed, AMBEL), Ambrosia trifida L. (giant ragweed, AMBTR), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Conyza canadensis (L.) Cronq. (horseweed, ERICA), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Salsola tragus L. (Russian thistle, SASKR), Sesbania exaltata (Raf.) Cory/Rydb. Ex Hill (hemp sesbania, SEBEX), Sida spinosa L. (prickly sida, SIDSP), Sida species (sida, SIDSS), Sinapis arvensis L. (wild mustard, SINAR), Sonchus arvensis L. (perennial sowthistle, SONAR), Solidago species (goldenrod, SOOSS), Taraxacum officinale G.H. Weber ex Wiggers (dandelion, TAROF), Trifolium repens L. (white clover, TRFRE), or Urtica dioica L. (common nettle, URTDI).

In some embodiments, the methods provided herein are utilized to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinylthiobenzoates, dimethoxy-pyrimidines, triazolopyrimidine sulfonamides, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidinediones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutanamides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes of action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to single or multiple herbicides, biotypes with resistance or tolerance to single or multiple chemical classes, biotypes with resistance or tolerance to single or multiple herbicide modes of action, and biotypes with single or multiple resistance or tolerance mechanisms (e.g., target site resistance or metabolic resistance).

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### Example 1

### Evaluation of Postemergence Herbicidal Activity of Mixtures in the Field

Methodology

Field trials were conducted in rice using standard herbicide small plot research methodology. The plot sizes were from 2×6 meter (m) to 5×5 meter with 4 replicates per treatment or single plot of 6×15 meter with 10 subsamples inside the plot. The rice crop was grown using normal cultural practices for fertilization, seeding, watering, flooding and maintenance to ensure good growth of the crop and the weeds.

All treatments in the field trials were applied using a compressed air backpack sprayer calibrated to apply 160 to 200 liters per hectare (L/ha) spray volume. Commercially available products of the premix penoxsulam plus triclopyr (GraspXTRA® herbicide, trademark of Dow AgroSciences LLC) and bispyribac-sodium were mixed in water at appropriately formulated product rates to achieve the desired rates based on a unit area of application (hectare) to achieve the desired rates as shown. Bispyribac was used as Nominee® 100SC or Nominee® 400SC. Treatments were evaluated at 6 to 40 days after application as compared to the untreated control plants.

The weed spectrum included, but was not limited to, Brachiaria platyphylla (Groseb.) Nash (broadleaf signalgrass, BRAPP), Digitaria sanguinalis (L.) Scop. (large crabgrass, DIGSA), Digitaria species (DIGSS), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (small-flower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SCPJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindemia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rottboellia exaltata (guineafowlgrass, ROOEX), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

The following abbreviations are used in the tables below:

g ai/ha=grams active ingredient per hectare

DAA=Days After Application

DIGSS=Digitaria species (DIGSS)

ECHCO=Echinochloa colonum (L.) LINK (junglerice, ECHCO)

ISCRU=Ischaemum rugosum Salisb. (saramollagrass)

ROOEX=Rottboellia exaltata (guineafowlgrass)

Evaluation

The treated plots and control plots were rated blind at various intervals after application. Ratings were based on a Percent (%) Visual Control basis, where 0% corresponds to no visual effect as exemplified by weed control or crop injury and 100% corresponds to complete kill of the target weeds or complete crop injury.

Colby's equation was used to determine the herbicidal effects expected from the mixtures (Colby, S.R. Calculation of the synergistic and antagonistic response of herbicide combinations. Weeds 1967, 15, 20-22).

The following equation was used to calculate the expected activity of mixtures containing three active ingredients, A. B, and C:

Expected=A+B+C−(AB+AC+BC)/100+(ABC)/10,000
A=observed efficacy of active ingredient A at the same concentration as used in the mixture;
B=observed efficacy of active ingredient B at the same concentration as used in the mixture;
C=observed efficacy of active ingredient C at the same concentration as used in the mixture.

However, the experiments described herein were performed such that active ingredients A and B were combined and only the efficacy of the combination was determined. As such, Colby's equation simplifies to

Expected=Z+C−(Z×C/100)
Z=observed efficacy a combination of active ingredient A (penoxsulam) and active ingredient B (triclopyr) at the same concentration as used in the mixture;
C=observed efficacy of active ingredient C (bispyribac) at the same concentration as used in the mixture.

Compounds tested, application rates employed, plant species tested, and results are given in Tables 1-2. All comparisons are an average of 4-10 replicates and are significant at the P>0.05 level. Rates of penoxsulam+triclopyr and bispyribac are expressed in grams active ingredient/hectare (g ai/ha).

TABLE 1
Synergistic Activity of Herbicidal Compositions of Penoxsulam plus Triclopyr
Tank-Mixed with Bispyribac-Sodium on Digitaria species (DIGSS),
Echinochloa colonum (L.) LINK (junglerice, ECHCO), Ischaemum rugosum
(Saramollagrass, ISCRU), and Rottboellia exaltata (Guineafowlgrass, ROOEX)
Control in the Field

| | | Penoxsulam + | | | | Mixture | |
|---|---|---|---|---|---|---|---|
| | Number of | Triclopyr | | Bispyribac-Sodium | | Observed | Expected |
| | Days after | Application | Percent | Application | Percent | Percent (%) | Percent (%) |
| | Application | Rate | (%) Visual | Rate | (%) Visual | Visual | Visual |
| Bayer Code | (DAA) | (g ai/ha) | Control | (g ai/ha) | Control | Control | Control |
| DIGSS | 6 | 364 | 90 | 50 | 93 | 100 | 99.35 |
| DIGSS | 17 | 364 | 52 | 50 | 88 | 99.2 | 94.4 |
| ECHCO | 30 | 350 | 73 | 52 | 86.25 | 100 | 96.55 |
| ISCRU | 12 | 280 | 0 | 50 | 30 | 52.5 | 30 |
| ISCRU | 12 | 364 | 0 | 50 | 30 | 75 | 30 |
| ISCRU | 27 | 280 | 0 | 50 | 9.25 | 65 | 9.25 |
| ISCRU | 27 | 364 | 0 | 50 | 9.25 | 65 | 9.25 |
| ISCRU | 6 | 364 | 0 | 50 | 0 | 100 | 0 |
| ISCRU | 17 | 364 | 0 | 50 | 0 | 99.3 | 0 |
| ISCRU | 40 | 364 | 0 | 50 | 0 | 97.7 | 0 |
| ISCRU | 16 | 364 | 0 | 50 | 46.8 | 62.5 | 46.8 |
| ISCRU | 32 | 364 | 0 | 50 | 0 | 50 | 0 |
| ROOEX | 16 | 364 | 0 | 50 | 87.3 | 98.5 | 87.3 |
| ROOEX | 32 | 364 | 0 | 50 | 69.5 | 96.5 | 69.5 |

TABLE 2
Safening Activity of Herbicidal Compositions of Penoxsulam plus
Triclopyr Tank-Mixed with Bispyribac-Sodium to Rice (Oryza
Sativa, ORYSA) in the Field

| | | Penoxsulam + | | | | | |
|---|---|---|---|---|---|---|---|
| | Number of | Triclopyr | | Bispyribac-Sodium | | Mixture | |
| | Days after | Application | Percent | Application | Percent | Observed | Expected |
| | Application | Rate | (%) Crop | Rate | (%) Crop | Percent (%) | Percent (%) |
| Bayer Code | (DAA) | (g ai/ha) | Injury | (g ai/ha) | Injury | Crop Injury | Crop Injury |
| ORYSA | 6 | 364 | 2.1 | 50 | 2.2 | 1.4 | 4.25 |
| ORYSA | 17 | 364 | 5.4 | 50 | 0.9 | 0 | 6.21 |
| ORYSA | 27 | 280 | 2.5 | 50 | 3 | 2.5 | 5.42 |
| ORYSA | 27 | 364 | 2.75 | 50 | 3 | 2.5 | 5.67 |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative composition materials and method steps disclosed herein are specifically described, other combinations of the composition materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

What is claimed is:

1. A method of controlling undesirable vegetation comprising contacting the vegetation or the locus thereof with a synergistic mixture of:
(a) penoxsulam or agriculturally acceptable salts thereof 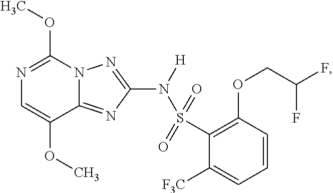 [SMILES: COc1cnc(OC)n2nc(NS(=O)(=O)c3c(OCC(F)F)cccc3C(F)(F)F)nc12]
(b) triclopyr or agriculturally acceptable salts or esters thereof
and 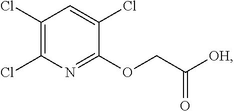 [SMILES: O=C(O)COc1nc(Cl)c(Cl)cc1Cl]
(c) bispyribac or agriculturally acceptable salts or esters thereof

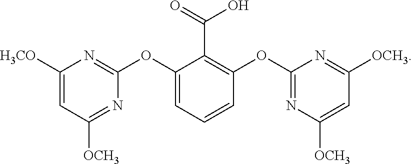 [SMILES: COc1cc(OC)nc(Oc2cccc(Oc3nc(OC)cc(OC)n3)c2C(=O)O)n1]

2. The method of claim 1, wherein (a) penoxsulam, (b) triclopyr and (c) bispyribac are applied post-emergence to the undesirable vegetation.

3. The method of claim 1, wherein the weight ratio of (a) penoxsulam (active ingredient) plus triclopyr (active ingredient) to (b) bispyribac (active ingredient) is from about 1:8.33:1.73 to about 1:8.33:1.28.

4. The method of claim 1, wherein the weight ratio of premixed (a) penoxsulam (active ingredient) and (b) triclopyr (active ingredient) to the tankmixed partner (c) bispyribac (active ingredient) is from about 1:1.47 to about 1620:1.

5. The method of claim 1, wherein the weight ratio of premixed (a) penoxsulam (active ingredient) and (b) triclopyr (active ingredient) to the tankmixed partner (c) bispyribac (active ingredient) is from about 1:0.029 to about 537:1.

6. The method of claim 1, wherein the weight ratio of premixed (a) penoxsulam (active ingredient) and (b) triclopyr (active ingredient) to (c) bispyribac (active ingredient) is from about 1:0.19 to about 7.3:1.

7. The method of claim 1, wherein (a), (b) and (c) are combined in a mixture.

8. The method of claim 1, wherein the difference between the observed and expected percent control as calculated by the Colby equation is greater than 15%.

9. The method of claim 1, wherein the undesirable vegetation comprises a herbicide resistant or tolerant weed.

10. The method of claim 9, wherein the resistant or tolerant weed is a biotype with resistance or tolerance to single or multiple herbicides or single or multiple chemical classes, or inhibitors of single or multiple herbicide modes-of-action.

11. The method of claim 9 or 10, wherein the resistant or tolerant weed is a biotype resistant or tolerant to acetolactate synthase (ALS) or acetohydroxy acid synthase (AHAS) inhibitors, photosystem II inhibitors, acetyl CoA carboxylase (ACCase) inhibitors, photosystem I inhibitors, 5-enolpyruvyl-shikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall or organoarsenicals.

12. The method of claim 1, wherein the undesirable vegetation is in rice, wheat, barley, oats, rye, sorghum, corn, maize, sugarcane, pastures, grasslands, rangelands, fallowland, turf, industrial vegetation management and aquatics.

13. The method of claim 1, further comprising contacting the undesirable vegetation with a herbicidally effective amount of an additional herbicide.

14. The method of claim 1, wherein the undesirable vegetation comprises one or more of Digitaria species, Echinochloa colonum (junglerice, ECHCO), Ischaemum rugosum (saramollagrass, ISCRU) and Rottboellia exaltata (guineafowlgrass, ROOEX).

15. A method for protecting crops from the harmful effects of one or more of penoxsulam, triclopyr, and bispyribac by contacting the crop with a synergistic mixture of:
(a) penoxsulam or agriculturally acceptable salts thereof 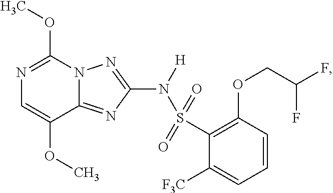 [SMILES: COc1cnc(OC)n2nc(NS(=O)(=O)c3c(OCC(F)F)cccc3C(F)(F)F)nc12]
(b) triclopyr or agriculturally acceptable salts or esters thereof
and 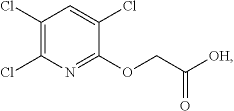 [SMILES: O=C(O)COc1nc(Cl)c(Cl)cc1Cl]
(c) bispyribac or agriculturally acceptable salts or esters thereof

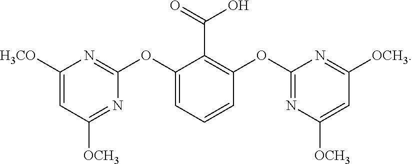 [SMILES: COc1cc(OC)nc(Oc2cccc(Oc3nc(OC)cc(OC)n3)c2C(=O)O)n1]

16. The method of claim 15, wherein (a) penoxsulam, (b) triclopyr and (c) bispyribac are applied post-emergence to the crop.

17. The method of claim 15, wherein the weight ratio of (a) penoxsulam (active ingredient) plus triclopyr (active ingredient) to (b) bispyribac (active ingredient) is from about 1:8.33:1.73 to about 1:8.33:1.28.

18. The method of claim 15, wherein the weight ratio of premixed (a) penoxsulam (active ingredient) and (b) triclopyr (active ingredient) to (c) bispyribac (active ingredient) is from about 1:1.47 to about 1620:1.

19. The method of claim 15, wherein the weight ratio of premixed (a) penoxsulam (active ingredient) and (b) triclopyr (active ingredient) to (c) bispyribac (active ingredient) is from about 1:0.29 to about 537:1.

20. The method of claim 15, wherein the weight ratio of premixed (a) penoxsulam (active ingredient) and (b) triclopyr (active ingredient) to (c) bispyribac (active ingredient) is from about 1:0.19 to about 7.3:1.

21. The method of claim 15, wherein (a), (b) and (c) are combined in a mixture.

22. The method of claim 15, wherein the difference between the observed and expected percent injury as calculated by the Colby equation is less than 7%.

23. The method of claim 15, wherein the crop comprises a herbicide resistant or tolerant crop.

24. The method of claim 23, wherein the crop is a biotype with resistance or tolerance to single or multiple herbicides or single or multiple chemical classes, or inhibitors of single or multiple herbicide modes-of-action.

25. The method of claim 23 or 24, wherein the resistant or tolerant crop is a biotype resistant or tolerant to auxins or acetolactate synthase (ALS) or acetohydroxy acid synthase (AHAS) inhibitors.
